(19) United States
(12) Patent Application Publication
(10) Pub. No.: US 2017/0279632 A1
(43) Pub. Date: Sep. 28, 2017

(54) GENERIC OPERATING ELEMENT FOR NETWORKED DOMESTIC APPLIANCES

(71) Applicant: BSH HAUSGERAETE GMBH, MUENCHEN (DE)

(72) Inventors: CHRISTOPH KOBER, OTTERFING (DE); INGO PIETSCH, MUENCHEN (DE); MIRCO WINDE, MUENCHEN (DE); ANDREAS WOERNER, MUENCHEN (DE)

(73) Assignee: BSH HAUSGERAETE GMBH, MUENCHEN (DE)

(21) Appl. No.: 15/508,500

(22) PCT Filed: Aug. 21, 2015
(86) PCT No.: PCT/EP2015/069201

§ 371 Date: Mar. 3, 2017

(30) Foreign Application Priority Data
Sep. 3, 2014 (DE) 10 2014 217 616.6

(51) Int. Cl. H04L 12/28

(52) U.S. Cl. CPC H04L 12/2816; H04L 12/282; H04L 12/2803; H04L 41/22

(57) ABSTRACT

A method creates an operating interface for a first domestic appliance from a plurality of domestic appliances. The method includes providing a plurality of different generic operating elements for specifying different functionalities and/or parameters of the plurality of domestic appliances. The method further includes determining description data for the first domestic appliance. The description data indicate which one or more of the plurality of generic operating elements are used to operate the first domestic appliance and which functionalities and/or parameter values of the first domestic appliance can be set by one or more generic operating elements used. The method also includes creating the operating interface for the first domestic appliance on the input/output unit of a control unit on the basis of the plurality of different generic operating elements and on the basis of the description data for the first domestic appliance.

The invention relates to a method and a corresponding apparatus, by means of which networked domestic appliances can be operated and monitored in an efficient manner.

Networked domestic appliances which can be operated and monitored via an App or a Web-based application are known. One of the challenges when developing such applications in this case is the plurality of different domestic appliance types with their respective domains, specific functions, parameters and options, and their respective dependencies. Furthermore, these different aspects can change dynamically during the running time of the domestic appliances and/or depending on domestic appliance accessories that are used (e.g. a meat temperature sensor in the case of an oven). A further challenge is the fact that a plurality of different individual appliances with different ranges of functions typically exist for each type of domestic appliance.

There are various approaches to solving these problems. The operating elements of an operating application can be developed or optimized, e.g. specifically for each individual domestic appliance and for all variants of control units (smart devices, tablet PCs, smartphones). This solution is very costly and therefore only a few select appliances can usually be operated. Moreover, the range of domestic appliance functions which can be operated via an operating application may be reduced in comparison with the range of functions on the domestic appliance itself. In this case, it is often only possible to operate the basic functions offered by most of the domestic appliances in a specific class. Furthermore, the operating application typically does not reflect dynamic changes in the range of functions or in the associated parameters or options depending on the currently selected function, the current operating state or the domestic appliance accessories in use. In most cases, the user therefore receives an information message or error report when attempting to access currently unavailable functions via the operating application. As a result of different operating applications for different domestic appliances, it is not generally possible to utilize the potential of a simplified operating model which is independent of appliance and appliance type.

The technical object of the present document is to provide an appliance-independent remote control for a plurality of domestic appliances in an effective manner.

This object is achieved by the independent claims. Advantageous embodiment variants are described inter alia in the dependent claims.

According to an aspect, a method is described for creating an operating interface for a first domestic appliance from a plurality of domestic appliances. The domestic appliances can comprise e.g. one or more ovens, one or more dishwashers, one or more washing machines, one or more dryers, etc. The operating interface can be provided on an electronic control unit. The electronic control unit can comprise a smartphone, a tablet PC, a laptop PC, etc. The electronic control unit can be connected to the first domestic appliance via a communication network (e.g. a wireless network such as WLAN, UMTS, LTE).

The method comprises providing a plurality of different generic operating elements for specifying different functionalities and/or parameters of the plurality of domestic appliances. The method also comprises determining description data for the first domestic appliance. The description data indicates which one or more of the plurality of generic operating elements are used to operate the first domestic appliance, and which versions of functionalities and/or which parameter values of the first domestic appliance can be set by means of the one or more generic operating elements used. The method also comprises creating the operating interface for the first domestic appliance on the input/output unit of the control unit on the basis of the plurality of different generic operating elements and on the basis of the description data for the first domestic appliance.

According to an aspect, a control unit is described which is so configured as to operate a first domestic appliance from a plurality of different domestic appliances. The control unit comprises a communication unit, which is so configured as to communicate with the first domestic appliance via a network. The control unit also comprises an input/output unit, which is so configured as to display an operating interface for the first domestic appliance and to capture inputs at the operating interface. The control unit also comprises a processor, which is so configured as to provide a plurality of different generic operating elements for specifying versions of different functionalities and/or values of different parameters of the plurality of different domestic appliances. The processor is moreover so configured as to determine description data for the first domestic appliance.

The description data indicates which one or more of the plurality of generic operating elements are used to operate the first domestic appliance, and which (versions of) functionalities and/or which parameters (or parameter values) of the first domestic appliance can be set by means of the one or more generic operating elements used. The processor is also so configured as to create the operating interface for the first domestic appliance on the basis of the plurality of different generic operating elements and on the basis of the description data for the first domestic appliance.

According to a further aspect, a software (SW) program is described. The SW program can be so configured as to be executed on a processor (e.g. on a processor of an electronic control unit) and thereby to execute the method described in this document.

According to a further aspect, a storage medium is described. The storage medium can comprise a SW program which is so configured as to be executed on a processor and thereby to execute the method described in this document.

It should be noted that the methods, apparatus and systems described in this document can be used alone or in combination with other methods, apparatus and systems described in this document. Moreover, any aspects of the methods, apparatus and systems described in this document can be combined with each other in many and diverse ways. In particular, the features in the claims can be combined with each other in many and diverse ways.

The invention is described in greater detail below, with reference to exemplary embodiments, wherein:

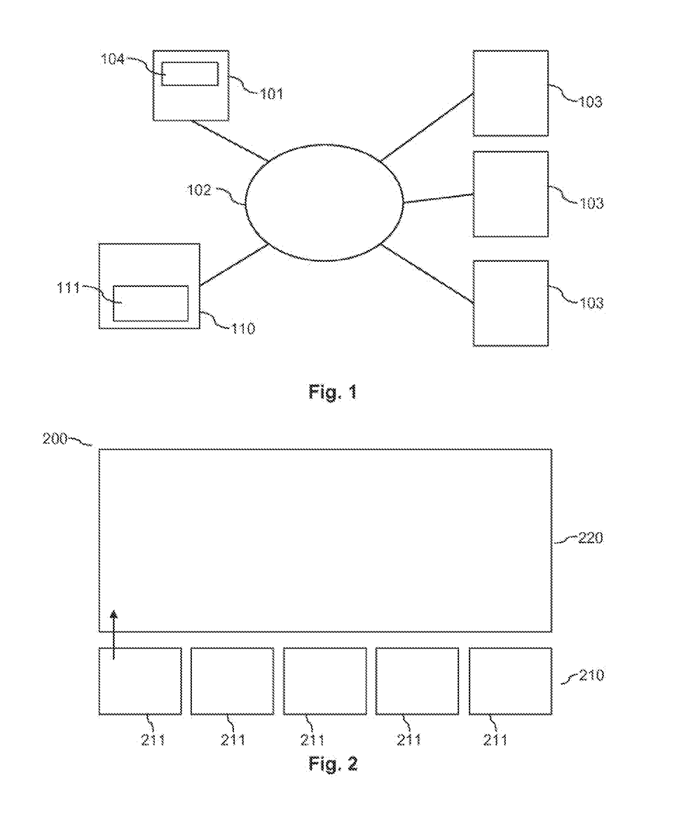

FIG. 1 shows an exemplary network with a plurality of domestic appliances;

FIG. 2 shows an exemplary structure of an operating interface;

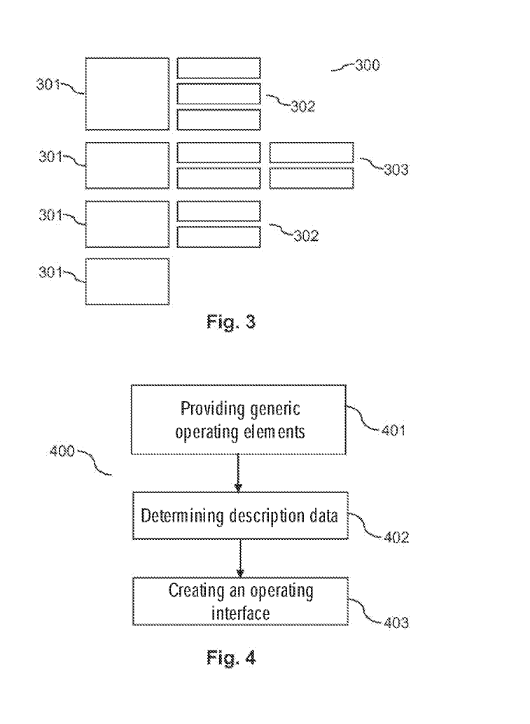

FIG. 3 shows an exemplary structure of a description file for the operating interface of a domestic appliance; and

FIG. 4 shows a flowchart of an exemplary method for creating an operating interface for a domestic appliance.

As stated in the introduction, the present document is concerned with providing operating interfaces for a plurality of domestic appliances in an efficient manner.

FIG. 1 shows a plurality of domestic appliances 103 (e.g. one or more ovens, one or more washing machines, one or more dryers, one or more dishwashers, etc.), which are connected to an electronic control unit 101 via a network 102. The network 102 can comprise a wireless and/or a wire-based network. Exemplary wireless networks comprise a WLAN, a UMTS and/or an LTE network. The electronic control unit 101 can comprise a tablet PC, a smartphone or a laptop PC. The electronic control unit 101 comprises an input/output unit 104 (e.g. a touch-sensitive display screen or touchscreen), which is so configured as to output pictorial information and to capture an input of a user. In particular, the input/output unit 104 can be so configured as to output a pictorial representation of an operating interface for a domestic appliance 103 and to capture inputs at the operating interface.

The electronic control unit 101 comprises a processor, which is so configured as to execute one or more software programs and/or instructions. In particular, with the aid of an operating program which is executed by the processor, the electronic control unit 101 can be so configured as to operate the plurality of domestic appliances 103 via the network 102 and/or to obtain status information relating to the plurality of domestic appliances 103 via the network 102. The operating program can comprise the operating interface described in this document. Moreover, the electronic control unit 101 can be so configured as to access an external computer (e.g. a server) 110 by means of the operating program. The computer 110 can comprise a storage unit 111 on which information relating to one or more of the plurality of domestic appliances 103 is stored. Exemplary information comprises a description file for an operating interface of a domestic appliance 103, operating instructions, collections of recipes, entries from user forums, etc.

The electronic control unit 101 illustrated in FIG. 1 can therefore be used to control one or more of the domestic appliances 103 and/or to obtain status information relating to one or more domestic appliances 103. For this purpose, the electronic unit 101 can optionally access the computer 110 (e.g. a Web server) in order to execute a Web-based operating program. Alternatively or additionally, the operating program can be provided at least partially on the electronic unit 101 (e.g. via an App).

As stated above, the present document is concerned with a method by means of which networked domestic appliances 103 can be operated via an App, via a Web site or via another external networked control unit 101. In this case, an operating interface having one or more operating elements is generated on the App, the Web site or the software of a control unit 101, wherein the operating interface allows simple appliance-specific operation of any type of domestic appliance 103 having any chosen range of functions, without it being necessary in this case to develop and implement a dedicated suitable operating interface for each domestic appliance type or each domestic appliance 103 having a different range of functions. Furthermore, effective provision is made to allow dynamic adaptation of the operating interface and the individual operating elements to current appliance statuses and to the functions, parameter ranges and options available in the respective status. The user is therefore provided with a generic operating interface for the control of domestic appliances via Apps, Web sites or software on a control unit 101, by means of which all types of domestic appliance 103 and any versions thereof can be operated using a consistent interaction model.

FIG. 2 shows an exemplary structure of an operating interface 200 for a domestic appliance 103. The operating interface 200 can also be referred to as a multi-control panel (MCP). The operating interface 200 comprises an operating elements region 210 having one or more operating elements 211. The operating interface 200 can also comprise a detail region 220, in which detailed information can be displayed and inputs captured for each operating element 211. The operating interface 200 can be displayed by the input/output unit 104 of the control unit 101. Furthermore, inputs on the operating interface 200 can be captured via the input/output unit 104. In a preferred example, the input/output unit 104 comprises a touch-sensitive display screen on which the operating interface 200 can be represented. The operating elements 211 can be activated by touching the operating elements 211 (or the corresponding icons).

The operating interface 200 for a domestic appliance 103 can be created automatically. A plurality of predefined generic operating elements 211 can be provided for this purpose. The generic operating elements 211 can be stored on the control unit 101 or on the central computer 110, for example. Each generic operating element 211 can be aimed at the setting and/or control of a functionality and/or a parameter of domestic appliances 103. Exemplary generic operating elements 211 include:
a program operating element 211, by means of which a program of a domestic appliance 103 can be selected;
a time operating element 211, by means of which a start time and/or a stop time for executing a program of a domestic appliance 103 can be specified;
a duration operating element 211, by means of which the running time of a domestic appliance 103 can be specified;
an options operating element 211, by means of which options (e.g. for the different programs) of a domestic appliance 103 can be specified;
a temperature operating element 211, by means of which an operating temperature of the domestic appliance 103 can be specified; and/or
a start/stop operating element 211, by means of which the operation of a domestic appliance 103 can be started, stopped and/or paused.

A pictorial representation and a means of interaction with a user can be specified for the individual generic operating elements 211. For the program operating element 211, for example, it can be specified that a currently selected program is displayed on the operating element 211 in the operating elements region 210, and/or that a selection of a program is effected by means of a list of programs displayed in the detail region 220. For a time operating element 211, it can be specified that currently selected start/stop times are represented on the operating element 211 in the operating elements region 210, and that a change of the times is effected by means of clocks that are represented in the detail region 220. For a duration operating element 211, it can be specified that a currently selected duration is represented on the operating element 211 in the operating elements region 210, and that a setting of the duration is effected by means of a scroll wheel on the operating element 211 in the operating elements region 210. For an options operating element 211, it can be specified that the options can be displayed and selected in the detail region 220. For a temperature operating element 211, it can be specified that a currently selected temperature is represented on the operating element 211 in the operating elements region 210, and that a setting of the temperature can be effected by means of a scroll wheel on the operating element 211 in the operating elements region 210. For a start/stop operating element 211, it can be specified that a start or a stop or a pause is effected by activating the operating element 211 and that the current status is displayed on the operating element 211 in the operating elements region 210.

The generic operating elements 211 can therefore be used to allow interaction of a consistent nature for the purpose of setting the different functionalities/parameters of a domestic appliance 103. In particular, it is possible by means of the generic operating elements 211 to provide a consistent operating interface 200 for a plurality of different domestic appliances 103.

In order to create a specific operating interface 200 for a specific domestic appliance 103, the specific domestic appliance 103 can provide a description file 300 (also referred to as description data 300) whereby it is possible to specify which generic operating elements 211 are used for the specific operating interface 200 and which actual versions of functionalities/actual values of parameters can be selected or set by means of the generic operating elements 211.

FIG. 3 shows an exemplary description file 300 for a domestic appliance 103. The description file 300 indicates (reference sign 301) which generic operating elements 211 are required for the purpose of controlling the domestic appliance 103. The description file 300 also indicates (reference sign 302) which actual versions of functionalities and/or which parameter ranges and/or which options can be input via the respective operating elements 211. For example:
for a program operating element 211, it is possible to indicate which specific programs can be selected for the specific domestic appliance 103;
for an options operating element 211, it is possible to indicate which actual options can be selected for the specific domestic appliance 103; and/or
for a temperature operating element 211, it is possible to indicate which temperature range can be selected for the specific domestic appliance 103.

The description file 300 can also specify (reference sign 303) dependencies between the settings in the different operating elements 211. In particular, the possible attributes and/or versions of a second operating element 211 (e.g. a temperature operating element) can depend on which attribute and/or version was selected for a first operating element 211 (e.g. a program operating element).

On the basis of the description file 300, it is therefore possible to select, from the list of available operating elements 211, those operating elements 211 which are required for the operation of a specific domestic appliance 103. It is also possible to define the possible attributes (e.g. versions of functionalities, parameter ranges, options, etc.) which can be input via the selected operating elements 211. It is thereby possible efficiently to provide different operating interfaces 200 for different domestic appliances 103, while nonetheless providing a consistent interaction model for the user.

The individual operating elements 211 enable a user to specify different parameters/functionalities of a domestic appliance 103, in particular a household domestic appliance. In this case, an operating element 211 can be so configured as to generate a control signal which represents an input that was entered at the operating element 211 (e.g. the selection of a program and/or the specification of a temperature). The control signal of an operating element 211 can be forwarded via the network 102 to the domestic appliance 103 to be operated, and thereby produce a corresponding setting on the domestic appliance 103.

A generic operating interface 200 having one or more generic operating elements 211 for domestic appliances is therefore described in this document. The generic operating interface 200 is also referred to in this document as a multi-control panel (MCP). The MCP 200 contains individual generic operating elements 211 for the different types of functionality that are required in order to control a domestic appliance 103. Using the example of an oven, these may be, for example, a generic operating element respectively for the heating type (top heating, bottom heating, etc.), the temperature, the start time, the running time and further options, and the appliance start. In the case of a dishwasher, generic operating elements 211 can be used for the washing program, for the program start, for program options and for the appliance start.

Precisely those functions offered by a specific domestic appliance 103 can be represented and made user-accessible within each of the generic operating elements 211. In the case of an oven, for example, provision may be made for representing only a few standard heating types (e.g. hot-air, top/bottom heat and grill) or a multiplicity of different heating types in the range of heating types, depending on the type of oven. The contents of the further generic operating elements 211 can be adapted as appropriate to the selection of the previous operating elements 211. For example, in the case of an oven, if the heating type “hot air” is selected in the operating element 211 for the heating type (i.e. in a program operating element), a different selection of possible temperatures will be displayed in the generic operating element 211 for the temperature than if the “grill” function was selected as heating type. On the other hand, if the oven also has a meat temperature sensor, a generic operating element 211 (e.g. an operating element 211 for the running time or duration) can be dynamically removed from the MCP 200 and replaced by an operating element 211 for setting the core temperature.

The desired characteristics of the operating interface 200 can be achieved as follows: A technical description file 300 is generated and supplied for each domestic appliance 103 to be controlled via the MCP 200. The description file 300 contains the range of functions, the associated parameter sets and options, and the respective dependencies for a domestic appliance 103. Generic operating elements 211 are provided for the superset of all appliance types and their functions, parameters and options. When a domestic appliance 103 is connected to the corresponding App, Web site or SW program of a control unit 101, the description file 300 of the domestic appliance 103 is read and interpreted in a rule-based manner. As a result, the generic individual operating elements 211 required for the operating interface 200 of the domestic appliance 103 are identified and displayed in the correct sequence and version by the input/output unit 104 of the control unit 101. Likewise, the respective range of functions, parameter ranges and options to be displayed in each generic operating element 211 are determined on the basis of the description file 300.

As set forth above, the domestic appliance 103 and the control unit 101 for realizing the remote control are typically connected together via a wireless network 102, e.g. WLAN, ZigBee, Bluetooth, etc. By means of this network 102, the control unit 101 can obtain information about the current status of a domestic appliance 103 and about the installation and/or removal of optional accessories, wherein this can have an influence on the current operating possibilities of the domestic appliance 103. Using a system of rules stored in the App, the Web site or the software of the control unit 101, and/or within the description file 300 for the respective domestic appliance 103, the MCP 200 can configure itself as appropriate for each domestic appliance 103 and the current operating state thereof, thereby making it possible to control any desired types of domestic appliance 103 and versions thereof at little expense.

FIG. 4 shows a flowchart of an exemplary method 400 for creating an operating interface 200 for a first domestic appliance 103. The first domestic appliance 103 in this case is a domestic appliance 103 from a plurality of different domestic appliances 103, in particular from a plurality of domestic appliances 103 of different types. Exemplary types of domestic appliance 103 include ovens, dishwashers, microwave ovens, washing machines, dryers, refrigerators, freezers, coffee/espresso machines, small appliances, etc. Furthermore, the different domestic appliances 103 may comprise different models of domestic appliances 103 of the same type, e.g. different models of ovens, dishwashers, microwave ovens, washing machines, dryers, etc.

The different models and/or the different types of domestic appliance can have different functionalities and/or parameters that can be set. Exemplary functionalities and/or parameters include predefined runtime programs of a domestic appliance 103, a start time and/or stop time of a predefined runtime program of a domestic appliance 103, a settable running time of a domestic appliance 103, settable options for the operation of a domestic appliance 103, an operating temperature of a domestic appliance 103, an operating power of a domestic appliance 103 and/or a start, a stop and/or a pause of the operation of a domestic appliance 103.

The method 400 comprises providing 401 a plurality of different generic operating elements 211 for specifying different functionalities and/or parameters of the plurality of domestic appliances 103. In this case, a generic operating element 211 which is designed for the purpose of setting a specific functionality and/or a specific parameter can typically be used to set this specific functionality and/or this specific parameter for more than one of the plurality of different domestic appliances 103. The generic operating element 211 is therefore designed in a generic manner for the purpose of setting a specific functionality and/or a specific parameter, irrespective of the actual versions of the specific functionality and/or specific parameter for an actual domestic appliance 101.

For example, the plurality of generic operating elements 211 can comprise a program operating element 211, by means of which a program of a domestic appliance 103 can be selected. In this case, the generic program operating element 211 is independent of the actual runtime programs that can be set for a specific domestic appliance 103. Alternatively or additionally, the plurality of generic operating elements 211 can comprise a time operating element 211, by means of which a start time and/or a stop time for executing a program of a domestic appliance 103 can be specified. Alternatively or additionally, the plurality of generic operating elements 211 can comprise a duration operating element 211, by means of which the running time of a domestic appliance 103 can be specified. Alternatively or additionally, the plurality of generic operating elements 211 can comprise an options operating element 211, by means of which options of a domestic appliance 103 can be specified. In this case, the generic options operating element 211 is independent of the actual options that can be set for a specific domestic appliance 103. Alternatively or additionally, the plurality of generic operating elements 211 can comprise a temperature operating element 211, by means of which an operating temperature of a domestic appliance 103 can be specified. In this case, the generic temperature operating element 211 is independent of the actual temperature ranges that can be set for a specific domestic appliance 103. Alternatively or additionally, the plurality of generic operating elements 211 can comprise a start/stop operating element 211, by means of which the operation of a domestic appliance 103 can be started, stopped and/or paused.

In a generic manner (i.e. irrespective of an actual domestic appliance 103), a generic operating element 211 can therefore provide an operating element 211 for an operating interface 200, by means of which logically similar functionalities and/or parameters of domestic appliances 103 can be set, irrespective of the actual versions of the functionalities and/or parameters for the different domestic appliances 103.

The generic operating element 211 can comprise or specify a graphical representation for the output on an input/output unit 104 of a control unit 101. The generic operating element 211 can therefore specify how the operating element for setting a specific functionality and/or a specific parameter is graphically represented. For example, a generic operating element 211 can be represented as a rectangular tile.

Furthermore, the generic operating element 211 can specify how a set version of the functionality and/or a set parameter value of a domestic appliance 103 is represented on the input/output unit 104. For example, the set version of a functionality and/or parameter can be represented within the rectangular tile of the operating element 211. Furthermore, the generic operating element 211 can specify a mechanism by means of which a version of a functionality and/or a parameter value can be set via the input/output unit 104. For example, the generic operating element 211 can specify that, in order to select a specific version, a list of possible versions of a functionality is represented in a detail region 220 of an operating interface 200.

A generic operating element 211 can also be so configured as to generate a control signal that indicates which version of a functionality and/or which parameter value has been set via the input/output unit 104. A corresponding setting/programming of a domestic appliance 103 can be produced by means of the control signal. In particular, the method 400 can comprise capturing an input or a setting via an operating element 211 of the operating interface 200 of the first domestic appliance 103. A corresponding control signal can then be generated by the operating element 211. The control signal can be sent to the first domestic appliance 103 in order to effect a setting, corresponding to the input, at the first domestic appliance 103. Remote control of the first domestic appliance 103 can be effected thus via an operating element 211.

The method 400 further comprises determining 402 description data 300 or a description file 300 for the first domestic appliance 103. In this case, the description data 300 indicates which one or more of the plurality of generic operating elements 211 are used to operate the first domestic appliance 103. In other words, the description data 300 indicates which generic operating elements 211 are used to create the operating interface 200 for the first domestic appliance 103.

The description data 300 also indicates which functionalities (in particular which versions of functionalities) and/or which parameter values of the first domestic appliance 103 can be set via the one or more generic operating elements 211 used. For example, for a generic program operating element 211, the description data 300 can specify which actual runtime programs can be selected for the first domestic appliance 103. In this case, the actual selectable runtime programs of the first domestic appliance 103 represent the possible versions of the “runtime programs” functionality. Alternatively or additionally, the description data 300 for a generic options operating element 211 can indicate which options can be selected for the first domestic appliance 103. In this case, the actual selectable options of the first domestic appliance 103 represent the possible versions of the “options” functionality or parameter. Alternatively or additionally, the description data 300 for a generic temperature operating element 211 indicates which temperatures (i.e. which actual parameter values of the “temperature” parameter) can be selected for the first domestic appliance 103.

The description data 300 can also specify one or more dependencies between a setting of a first operating element 211 and possible selectable (versions of) functionalities and/or parameter values of a second operating element 211. For example, the temperature values that can be set via a temperature operating element may depend on the runtime program that has been set in the program operating element.

The method 400 also comprises creating 403 the operating interface 200 for the first domestic appliance 103 on the input/output unit 104 of a control unit 101 on the basis of the plurality of different generic operating elements 211 and on the basis of the description data 300 for the first domestic appliance 103. In this case, the creation 403 of the operating interface 200 for the first domestic appliance 103 can comprise in particular selecting the one or more generic operating elements 211 for the operation of the first domestic appliance 103 on the basis of the description data 300 of the first domestic appliance 103. The creation 403 of the operating interface 200 for the first domestic appliance 103 can also comprise specifying, on the basis of the description data 300, the settable (versions of the) functionalities and/or the settable parameter values of the first domestic appliance 103 for the selected one or more generic operating elements 211, in order to provide one or more corresponding specific operating elements 211 of the operating interface 200 for the first domestic appliance 103. Furthermore, the creation 403 of the operating interface 200 for the first domestic appliance 103 can comprise the output of graphical representations of the one or more specific operating elements 211 of the operating interface 200 on the input/output unit 104 of the control unit 101. The graphical representations specified for the corresponding generic operating elements 211 can be used for this purpose.

As a result of using a limited number of generic operating elements 211 and providing description data 300 for a plurality of different domestic appliances 103, the method 400 therefore allows specific operating interfaces 200 to be created in an efficient manner for the plurality of different domestic appliances 103. The operating interfaces 200 created in this way moreover exhibit a coherence which allows a user easily to operate the plurality of different domestic appliances 103.

The method 400 can further comprise determining a status and/or a feature level of the first domestic appliance 103. For example, the first domestic appliance 103 may comprise optional accessories (e.g. a core temperature sensor), which should be taken into consideration when the first domestic appliance 103 is operated. The description data 300 of the first domestic appliance 103 can indicate which one or more of the plurality of generic operating elements 211 are used to operate the first domestic appliance 103, depending on the status and/or the feature level. A dynamic adaptation of the operating interface 200 can therefore take place in an efficient manner. In particular, the method 400 can also comprise detecting that the status and/or the feature level of the first domestic appliance 103 has changed. The operating interface 200 can then be adapted depending on the changed status and/or the changed feature level. For example, in the event of a change in feature level, a new operating element 211 can be included in the operating interface 200 and/or different versions of functionalities can be offered for selection.

Furthermore, the method 400 can comprise determining the type of the control unit 101 by means of which or for which the operating interface 200 is to be provided. Control units 101 differ in respect of e.g. the type of input/output unit 104, the size of a screen on which the operating interface 200 is to be displayed, operating characteristics of an operating system (e.g. Android, iOS, etc.) and/or in respect of the input device (smartphone, tablet PC, PC). The operating interface 200 can be created depending on the type of the control unit 101. For example, the number of operating elements 211 can be limited to a specified maximum depending on the type of the control unit 101. The pictorial representation of the operating elements 211 can also be adapted to the type of the control unit 101. In this way, the interaction with the first domestic appliance 103 via the operating interface 200 can be improved for a user.

By virtue of the method 400 described in this document, it is possible significantly to reduce the expense of developing operating interfaces 200 for networked domestic appliances 103. The one-off development of generic operating elements 211 and the provision of a system of rules for the representation are sufficient to allow correct and simple operation of any type of domestic appliance 103. For this purpose, the range of functions, the possible parameter values and options are described in a description file 300 for a domestic appliance 103.

For a user, the method 400 described above offers the advantage that the operating elements 211 always reflect the range of possibilities that are actually available at the present time for setting and operating the domestic appliance 103. The complete range of functions of the domestic appliance 103 is therefore also available at an external operating unit 101. Moreover, it is also possible dynamically to offer only those functions, parameters and options, for the purpose of selection and operation, which are actually available depending on the appliance type, the current appliance status, and the appliance accessories used.

A further advantage for the user is a consistent operating logic resulting from generically produced consistent operating elements 211 within the MCP 200 for different types and versions of domestic appliances 103, including those of different manufacturers if applicable. In this case, the individual generic operating elements 211 can be optimized for the respective intended use by means of usability engineering methods. Moreover, the generic operating elements 211 are not subject to the different restrictions of the respective appliance-specific general conditions of the different types of domestic appliances 103. One-off learning of the interaction model of the MCP 200 is therefore sufficient to enable the user to operate the widest variety of appliances 103 with ease.

Moreover, it is possible to respond to the individual operating characteristics of the smart devices (smartphone, tablet, PC) and implement a respectively adapted model of the MCP 200 which is based on the usability attributes of the respective control unit 101.

The present invention is not restricted to the exemplary embodiments shown here. In particular, it should be noted that the description and the figures are intended merely to illustrate the principle of the proposed method, apparatus and systems.

### LIST OF REFERENCE SIGNS

101 Electronic control unit
102 Network (possibly wireless)
103 Domestic appliance
104 Input/output unit of the electronic unit 101
110 External computer
111 Storage unit of the computer 110
200 Operating interface 200
210 Operating elements region
211 Operating element
220 Detail region
300 Description file or description data
301 Required operating elements
302 Possible attributes (e.g. functionalities and/or parameter values)
303 Dependencies/conditions
400 Method for creating an operating interface for remote control of a domestic appliance 103
401, 402, 403 Steps of the method 400

1-15. (canceled)

16. A method for creating an operating interface for a first domestic appliance of a plurality of domestic appliances, which comprises the steps of:
providing a plurality of different generic operating elements for specifying different functionalities and/or parameters of the plurality of domestic appliances;
determining description data for the first domestic appliance, the description data indicating which of the different generic operating elements are used to operate the first domestic appliance, and which functionalities values and/or parameter values of the first domestic appliance can be set via at least one of the different generic operating elements used; and
setting the operating interface for the first domestic appliance on an input/output unit of a control unit on a basis of the plurality of different generic operating elements and on a basis of the description data for the first domestic appliance.

17. The method according to claim 16, wherein each of the different generic operating elements:
contains a graphical representation for an output on the input/output unit;
specifies how a set functionality value and/or a set parameter value of the first domestic appliance is represented on the input/output unit; and/or
specifies a mechanism by which a functionality value and/or a parameter value can be set via the input/output unit.

18. The method according to claim 16, wherein the plurality of different generic operating elements comprises at least one of the following:
a program operating element, by means of which a program of the first domestic appliance can be selected;
a time operating element, by means of which a start time and/or a stop time for executing the program of the domestic appliance can be specified;
a duration operating element, by means of which a running time of the first domestic appliance can be specified;
an options operating element, by means of which options of the first domestic appliance can be specified;
a temperature operating element, by means of which an operating temperature of the first domestic appliance can be specified; or
a start/stop operating element, by means of which an operation of the first domestic appliance can be started, stopped and/or paused.

19. The method according to claim 16, wherein a different generic operating element for a specific functionality and/or for a specific parameter can be used for setting the specific functionality and/or the specific parameter of the plurality of different domestic appliances.

20. The method according to claim 16, wherein the functionalities and/or the parameters contain at least one of the following:
predefined runtime programs of the first domestic appliance;
a start time and/or stop time of a predefined runtime program of the first domestic appliance;
a running time of the first domestic appliance;
settable options for an operation of the first domestic appliance;
an operating temperature of the first domestic appliance; or
a start, a stop and/or a pause of the operation of the first domestic appliance.

21. The method according to claim 16, wherein at least one of the different generic operating elements is configured to generate a control signal, which indicates which version of a functionality and/or which parameter value has been set via the input/output unit.

22. The method according to claim 21, which further comprises:
capturing an input via one of the different generic operating elements of the operating interface of the first domestic appliance;
generating a corresponding control signal by means of the one different generic operating element; and
sending the corresponding control signal to the first domestic appliance in order to effect a setting, corresponding to the input, at the first domestic appliance.

23. The method according to claim 16, wherein
the description data for a generic program operating element indicates which actual runtime programs can be selected for the first domestic appliance;
the description data for a generic options operating element indicates which options can be selected for the first domestic appliance; and/or
the description data for a generic temperature operating element indicates which temperatures can be selected for the first domestic appliance.

24. The method according to claim 16, wherein the description data specifies a dependency between a setting of a first operating element and possible selectable functionalities and/or parameter values of a second operating element.

25. The method according to claim 16,
which further comprises determining a status and/or a feature level of the first domestic appliance; and
wherein the description data indicates which of the plurality of different generic operating elements are used to operate the first domestic appliance depending on the status and/or the feature level.

26. The method according to claim 25, which further comprises:
detecting that the status and/or the feature level of the first domestic appliance has changed; and
adapting the operating interface depending on a changed status and/or a changed feature level.

27. The method according to claim 16, wherein a creation of the operating interface for the first domestic appliance further comprises the further steps of:
selecting at least one of the different generic operating elements for an operation of the first domestic appliance on a basis of the description data; and
specifying, on the basis of the description data, settable functionalities and/or settable parameter values of the first domestic appliance for a selected generic operating element, in order to provide at least one of the different generic operating elements of the operating interface.

28. The method according to claim 27, wherein the creation of the operating interface for the first domestic appliance comprises an outputting of graphical representations of the at least one generic operating element of the operating interface on the input/output unit of the control unit.

29. The method according to claim 16, which further comprises:
determining a type of the control unit by means of which the operating interface is to be provided; and
creating the operating interface depending on the type of the control unit.

30. A control unit for operating a first domestic appliance from a plurality of different domestic appliances, the control unit comprising:
a communication unit configured to communicate with the first domestic appliance via a network;
an input/output unit configured to display an operating interface for the first domestic appliance and to capture inputs at said operating interface; and
a processor, configured to:
provide a plurality of different generic operating elements for specifying different functionalities and/or parameters of the plurality of different generic domestic appliances;
determine description data for the first domestic appliance, wherein the description data indicates which one of the plurality of different generic operating elements are used to operate the first domestic appliance, and which of the functionalities and/or the parameter values of the first domestic appliance can be set via the different generic operating elements used; and
create the operating interface for the first domestic appliance on a basis of the plurality of different generic operating elements and on a basis of the description data for the first domestic appliance.
